(19) United States
(12) Patent Application Publication
(10) Pub. No.: US 2026/0091554 A1
(43) Pub. Date: Apr. 2, 2026

(54) MATERIAL-TRANSFER, LIGHT CURE ADDITIVE MANUFACTURING SYSTEM AND PROCESS

(71) Applicant: Supernova Industries Corp., Austin, TX (US)

(72) Inventors: Roger Antunez Francisco, Barcelona (ES); Alex LaVelle, Austin, TX (US); Nirup Nagabandi, Pflugerville, TX (US); Marta Mico Martinez, Barcelona (ES)

(21) Appl. No.: 19/343,270

(22) Filed: Sep. 29, 2025

Related U.S. Application Data
(60) Provisional application No. 63/700,067, filed on Sep. 27, 2024.

(51) Int. Cl. B29C 64/329; B29C 64/124; B29C 64/236; B29C 64/241; B29C 64/245; B29C 64/364; B33Y 10/00; B33Y 30/00; B33Y 40/00

(52) U.S. Cl. CPC B29C 64/329; B29C 64/124; B29C 64/236; B29C 64/241; B29C 64/245; B29C 64/364; B33Y 10/00; B33Y 30/00; B33Y 40/00

(57) ABSTRACT

An additive manufacturing machine and a method of printing a polymer precursor that exhibits a viscosity in the range of 1,000 centipoise to 2,000,000 centipoise. The additive manufacturing machine includes a light engine and a material feed system configured to feed a polymer precursor exhibiting a viscosity in the range of 1,000 to 200,000,000 centipoise, wherein the material feed system includes a hopper and a roller train, wherein the hopper delivers the polymer precursor to the roller train and the polymer precursor passes through the roller train. The additive manufacturing machine also includes a transfer film configured to carry the polymer precursor and move between the material feed system and the light engine and a support surface positioned at least partially under the light engine and moveable vertically towards and away from the light engine.

### CROSS-REFERENCE TO RELATED APPLICATIONS

The present application claims the benefit of U.S. Provisional Application No. 63/700,067, filed Sep. 27, 2024, the teachings of which are incorporated by reference.

### FIELD

The present disclosure relates to the three dimensional (3D) printing using a material-transfer, light cure additive manufacturing machine and process.

### INTRODUCTION

In a number of applications it is desirable to form components from polymers precursors exhibiting relatively high viscosities, such as in the range of 20,000 centipoise or greater. Such polymers may be filled and have filler loadings of 60 percent by weight or greater. These applications include but are not limited to battery electrodes, ceramics, metallurgy, electronic housings, energetic materials, and solid propellant applications. There are many challenges in manufacturing for such applications, including material processibility due to the increases in viscosity of the molding material or their polymer binder precursors as the filler loading level increases and the increased effects of filler geometry on material behavior. While extrusion and casting have been used in forming viscous polymers, geometries formed using these methods are limited. In addition, extrusion dies and molds are usually necessary for forming these materials. Challenges exist in high solid load material processing applications like higher explosives, ceramic green parts, hypersonic vehicle shells, battery electrode manufacturing, where laborious, energy intensive, mold forming or other forming methods are employed due to lack of other reliable methods at scale.

Additive manufacturing is a process of forming parts by depositing one or more materials layer by layer, “building up” a component. The process generally utilizes digital computer models, such as a computer-aided designs or digital 3D models, sliced into layers, to control the selective deposition, melting, curing, and/or binding of material. Additive manufacturing accommodates complex geometries without the need for molds or dies.

There are a number of additive manufacturing techniques that can be used for the formation of parts from viscous materials. However, not all techniques are suitable for all applications. Fused deposition molding is commonly used for extruding thermoplastic materials including relatively low solids loadings, such as at 30 percent by weight loadings or less, depending on the solids. Solids include, for example, at least one of powders and fibers. If the solids loading is too high, then the filament becomes brittle and cannot be spooled, or snaps during feeding. In forming propellants for rockets and munitions, high explosives, and ceramics methods of 3D printing utilizing high energy to melt a polymer binder, such as in fused deposition molding or laser sintering, may result in igniting the propellant. Thus, in applications where solid loading in a binder is preferably 60 percent or greater, and up to 99 percent, the manufacturing method must be capable of deposition, melting, curing, and/or binding of the material and layers to form the component.

Accordingly, room remains for improvement of additive manufacturing systems and methods for improved manufacturing of filled polymers including 60 percent or more by weight of a filler.

### SUMMARY

Accordingly, in aspects, the present disclosure relates to an additive manufacturing machine. The additive manufacturing machine includes a light engine and a material feed system configured to feed a polymer precursor exhibiting a viscosity in the range of 1,000 to 200,000,000 centipoise, wherein the material feed system includes a hopper and a roller train, wherein the hopper delivers the polymer precursor to the roller train and the polymer precursor passes through the roller train. The additive manufacturing machine also includes a transfer film configured to carry the polymer precursor and move between the material feed system and the light engine and a support surface positioned at least partially under the light engine and moveable vertically towards and away from the light engine.

In embodiments of the above, the additive manufacturing machine further includes at least two support surfaces. The support surfaces are supported by a rotatable print bed and the support surfaces are indexable between a first position under the light engine to a second position adjacent a post processing device. In further embodiments, the post processing device includes at least one of a milling machine, a router, a knife, a polishing element, and a drill.

In any of the above embodiments, the material feed system includes an idle roller for supporting the transfer film, and the roller train includes a directional roller, wherein the roller train feeds the polymer precursor onto the transfer film between the directional roller and the idle roller.

In any of the above embodiments, the additive manufacturing machine further includes a release film, wherein the release film and the transfer film are configured to pass through the roller train, the hopper is configured to deposit the polymer precursor between the release film and the transfer film prior to the film entering the roller train, and the release film is configured to separate from the transfer film and polymer precursor upon exiting the roller train.

In embodiments of the above, the roller train includes a transfer roller that contacts the transfer film and a release roller that contacts the release film, and the transfer film and the release film pass through the transfer roller and the release roller.

In further embodiments of the above, the release roller includes a first end and a second end, a first motor configured to linearly adjust the first end of the release roller relative to the transfer roller, and a second motor configured to linearly adjust the second end of the release roller relative to the transfer roller.

In yet further embodiments of the above, the additive manufacturing machine includes a transfer film supply roller, wherein the transfer film is configured to be unwound from the transfer film supply roller before the transfer film passes through the roller train; and a release film supply roller, wherein the release film is configured to be unwound from the release film supply roller before the release film passes through the roller train. T

In further embodiments of the above, the additive manufacturing machine includes a release film take-up roller, wherein the release film is configured to be wound around the release film take-up roller after the release film passes through the roller train.

In additional further embodiments of the above, the additive manufacturing machine includes a first tension roller and a first nip roller, wherein the transfer film is configured to pass through the first tension roller and the first nip roller prior to passing through the roller train.

In addition, in embodiments, the additive manufacturing machine includes a lower idle roller, an upper idle roller, and a storage roller, wherein the transfer film is configured to pass under the lower idle roller after the transfer film passes through the roller train and around the upper idle roller prior to passing under the light engine, and wherein the transfer film is configured to be wound around the storage roller after the transfer film passes under the light engine.

In addition, in embodiments, the additive manufacturing machine includes a second tension roller and a second nip roller, wherein the transfer film is configured to pass between the second tension roller and second nip roller after passing under the light engine and before being wound around the storage roller.

In any of the above embodiments, the additive manufacturing machine includes a vacuum disposed proximal to the post-processing device.

According to various additional aspects, the present disclosure relates to a method for additive manufacturing. The method includes depositing a polymer precursor onto a transfer film, passing the polymer precursor through a roller train, moving the transfer film including the polymer precursor under a light engine, raising a support surface toward the light engine and the polymer precursor on the transfer film, contacting the polymer precursor with at least one of the support surface and a previously printed layer on the support surface, activating a light source to at least partially cure the polymer precursor, and transferring the at least partially cured the polymer precursor onto at least one of the support surface and the previously printed layer on the support surface to form a component.

In embodiments of the above, the method includes indexing the support surface adjacent a post processing device and adjusting a dimension of the component with the post processing device.

In any of the above embodiments, polymer precursor is deposited on the transfer film after passing through the roller train. Alternatively, the method further includes sandwiching the polymer precursor between the transfer film and a release film, passing the transfer film, the release film, and the polymer precursor through the roller train, and removing the release film prior to raising the support surface toward the light engine and the polymer precursor on the transfer film.

In further embodiments, the method includes unwinding the transfer film from a transfer film supply roller and passing the polymer film between a first tension roller and a first nip roller before sandwiching the polymer precursor between the transfer film and the release film.

In further embodiments, the method includes passing the transfer film under a lower idle roller and around an upper idle roller before moving the transfer film and polymer precursor under the light engine. In addition, the method includes winding the transfer film onto a storage roller after transferring the at least partially cured polymer precursor onto the at least one of the support surface and the previously printed layer on the support surface.

In further embodiments, the method includes unwinding the release film from a release film supply roller before sandwiching the polymer precursor between the transfer film and the release roller, separating the release film from the polymer precursor and transfer film after the release film passes through the roller train, and winding the release film on a release film take up roller.

### BRIEF DESCRIPTION OF THE DRAWINGS

The drawings described herein are for illustration purposes only and are not intended to limit the scope of the present disclosure in any way.

FIG. 1 illustrates an additive manufacturing machine according to embodiments of the present disclosure.

FIG. 2 illustrates a print bed, support surface, light engine, and gravity fed hopper according to embodiments of the present disclosure.

FIG. 3 illustrates a transfer film shuttle system according to embodiments of the present disclosure.

FIG. 4 illustrates a material feed system according to embodiments of the present disclosure.

FIG. 5 illustrates a material feed system according to embodiments of the present disclosure.

FIG. 6 illustrates a material feed system according to embodiments of the present disclosure.

FIG. 7 illustrates an additive manufacturing system according to embodiments of the present disclosure.

FIG. 8 illustrates a roller train according to embodiments of the present disclosure.

FIG. 9 illustrates a print bed and support surfaces according to embodiments of the present disclosure.

FIG. 10 illustrates a print bed, light engine, post processing device, and vacuum according to embodiments of the present disclosure.

FIG. 11 illustrates a method of forming a component using an additive manufacturing machine according to embodiments of the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure relates to an additive manufacturing system and process, and, in particular, to a material-transfer, light cured additive manufacturing system and process. The system and process may be used with polymer precursors that are at least one of 1) viscous, and 2) highly filled. The polymer precursors may exhibit varying degrees of tack. Viscous polymer precursors are understood to exhibit pre-cursor viscosities of 20,000 centipoise or greater. Highly filled polymer precursors are understood to include a filler loading of 60 percent by weight or greater, including all values and ranges such as from 60 percent by weight to 99 percent by weight filler. As may be appreciated, at the higher end of filler loadings, the materials are powderier in nature. While the present technology is described primarily herein in connection with battery electrodes, ceramics, metallurgy, electronic housings, energetic materials, and solid propellant applications, the technology is not limited to these applications. Many other applications are contemplated herein that utilize polymers that include 1) at least one of relatively high filler loadings of 60 percent by weight or greater and 2) polymers exhibiting pre-cursor viscosities of 20,000 centipoise or greater at room temperature.

The unfilled polymer precursors exhibit a viscosity of 20,000 centipoise or greater, such as in the range of 1 centipoise to 200,000,000 centipoise, including all values and ranges therein such as in the range of 1,000 centipoise to 200,000,000 centipoise, 20,000 centipoise to 1,500,000 centipoise, 20,000 centipoise to 50,000 centipoise, 20,000 centipoise to 10,000 centipoise, etc. In embodiment, the minimum amount of force for the polymer precursor to flow is higher than the force of gravity. Stated another way, and without being bound to any particular theory, the polymer precursor may exhibit the characteristic of a Bingham plastic and exhibits a yield stress limit that must be exceeded before deformation can occur, wherein the yield stress limit is greater than the force of gravity. In embodiments, the polymer precursors resemble lard, caulking compound, window putty, or dough and may include solid particles. The polymer precursors include photo-curable precursors. Light, exhibiting one or more wavelengths in the range of 250 nanometers to 750 nanometers, including all values and ranges therein, is used to polymerize the precursors. In embodiments, the polymer precursors are cured using light exhibiting one or more wavelengths in the range of 250 to 750 nanometers, and preferably in the range of 250 nanometers to 435 nanometers, including all values and ranges therein. In embodiments, the polymer precursors include at least one of a monomer and an oligomer, at least one photoinitator, and, optionally, one or more fillers and additives.

The monomers and oligomers include, but are not limited to, one or more of the following: acrylate, methacrylate, cationic epoxies, liquid silicone, liquid polyurethane, urethane monomers, and hydroxyl terminated polybutadienes. In further embodiments, the monomers and oligomers include methacrylates and acrylates functional groups on linear urethane, silicone, or polyolefin (polypropylene, polyethylene) backbones. The photoinitators, in embodiments, include at least one of a type I photoinitators such as hydroxyacetophenone (HAP) and phosphineoxide (TPO), and a type II photoinitiator such as Benzophenone and benzophenone-type photoinitiators, which also require the use of a co-initiator such as an alcohol or an amine. The photoinitators (and co-initiators, if present) are present in the range of 0.01 percent by weight to 5 percent by weight, including all values and ranges therein.

The fillers include, but are not limited to one or more of the following: ceramics including silica, alumina, zirconia, ferrites, barium titanate, silicon carbide, silicon nitride, boron carbide, hydroxyapatite, zinc oxide, and combinations thereof; metals including but not limited to one or more transition metals, which are understood as metals that include valence electrons in two shells instead of only one; metal alloys, which are understood to include one or more metals or mixes one or more metals with one or more non-metallic elements; explosives and propellants including but not limited to potassium nitrate, ammonium perchlorate, pentaerythritol tetranitrate, hexogen, octogen, nitrocellulose, hexanitrostilbene, 2,4,6-triamino-1,3,5-trinitrobenzene, bis(2,2-dinitropropyl) acetal and bis(2,2-dinitropropyl) formal mixtures, trimethylolethane trinitrate, aluminum, beryllium, and diaminotrinitrobenzene; optionally, oxidizing agents such as ammonium nitrate, ammonium dinitramide, ammonium perchlorate, and potassium nitrate; battery anode materials; and battery cathode materials such as Lithium Nickel Manganese Cobalt Oxide, Lithium Iron Phosphate (LFP), Lithium Cobalt Oxide (LCO), Lithium Nickel Cobalt Aluminum Oxide (NCA), Lithium Manganese Oxide (LMO) Graphite (Natural and Synthetic), Silicon-Graphite Composite, Lithium Titanate (LTO), Hard Carbon, Soft Carbon, their sodium, magnesium, and zinc alternates. Other additives may be added including plasticizers such as dioctyl adipate, diisooctyl phthalate; and additional fillers such as carbon black, silica in non-ceramic based formulations, glass, and rosin, etc. The fillers may be present in the range of 60 percent by weight to 99 percent by weight of the total weight of the polymer precursor, including all values and ranges therein such as 60 percent by weight to 95 percent by weight, 75 percent by weight to 80 percent by weight, 85 percent by weight to 95 percent by weight, etc. The polymer precursors including fillers may exhibit a viscosity in the range of 20,000 to 10,000,000 centipoise, including all values and ranges therein.

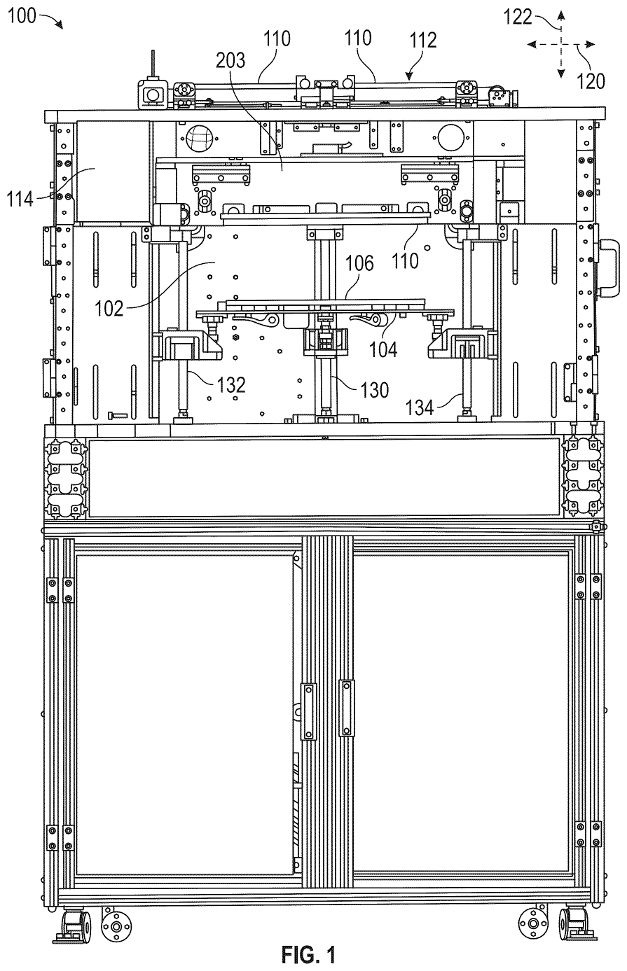

FIG. 1 illustrates an additive manufacturing machine 100 for forming components using, but not limited to, the polymer precursors described above. The additive manufacturing machine 100 defines a process chamber 102. In embodiments, the temperature and the humidity is controlled within the process chamber 102. Within the process chamber 102 is a print bed 104 including a support surface 106 on which a component is printed. The additive manufacturing machine 100 further includes a transfer film 110 and a transfer film shuttle system 112 for moving the transfer film 110 back and forth between a material feed system 114 and a light engine 116 over the print bed 104.

In operation, a layer of the polymer precursor is dispensed by the material feed system 114 onto the transfer film 110, and specifically to the underside of the transfer film 110 facing the support surface 106. The transfer film 110 is shuttled over along in a first axis 120 so that the polymer precursor is positioned over the support surface 106 of the print bed 104 and under the light engine 116. The support surface 106 is then raised in a second axis 122, the “z-direction” or vertically, toward the transfer film 110 and the light engine and contacts the polymer precursor. The light source 300 in the light engine 116 is activated and projected through the transfer film 110 onto the polymer precursor at a sufficient dosage to at least partially cure or solidify the polymer precursor in specific locations that form the component layer. If previous layers of the component are present, the polymer precursor may also bind to the previously printed layers. The at least partially cured polymer precursor is transferred to the support surface 106 of the print bed 104 and the print bed 104 is lowered along the second axis 122.

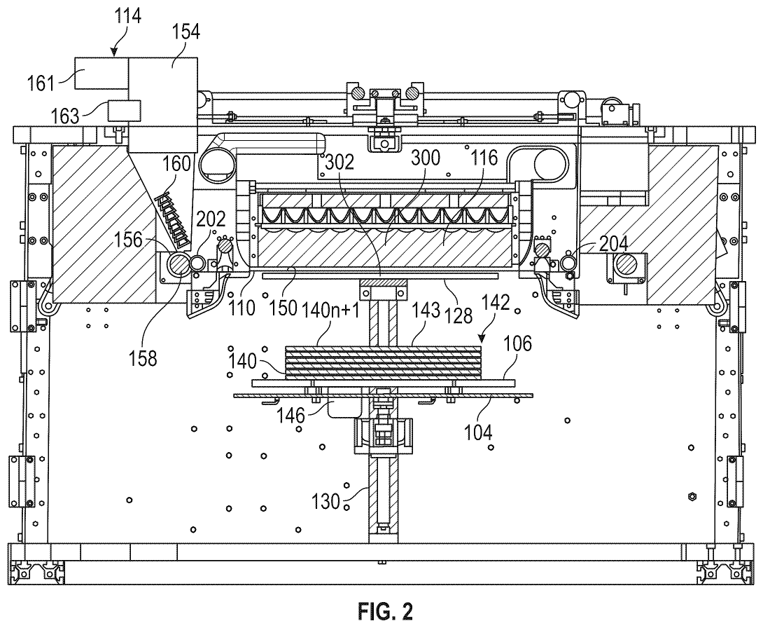

Turning now to FIG. 2, with further reference to FIG. 1, the print bed 104 is coupled to at least three indexing systems 130, 132, 134 for moving the print bed 104 up and down in the second axis 122, i.e., the z-direction. In alternative embodiments, one, two, four or more indexing systems may be provided. The indexing systems 130, 132, 134 may include, for example, a ball screw drive, roller screw drive, linear motor, etc. Supported on the print bed 104 is a support surface 106 on which the various layers 140, 140 n+1 of the component 142 are created. The print bed 104 also includes, in embodiments, a vibration apparatus 146 to vibrate the print bed 104 and support surface 106 as the component 142 is being printed to release air bubbles from the polymer precursor and compact the polymer precursor, particularly if the polymer precursor is filled. In additional or alternative embodiments, a vibration apparatus 163 is included in the material feed system 114 as illustrates in FIG. 2. In embodiments, the vibration apparatus 146 is at least one of a piezoelectric transducer, a mechanical vibrator such as an eccentric rotating mass or a linear resonant actuator, and an ultrasonic generator. In embodiments, the vibration apparatus 146 exhibits various amplitudes in the range of 1 millimeter to 10 millimeters, including all values and ranges therein, and vibration frequencies may range of a few milliseconds to 1 seconds, such as in the range of 10 milliseconds to 1 second, including all values and ranges therein. Further, for each printed polymer precursor layer 140, 140n+1 deposited, the vibration may last for 5 seconds to 30 seconds, including all values and ranges therein.

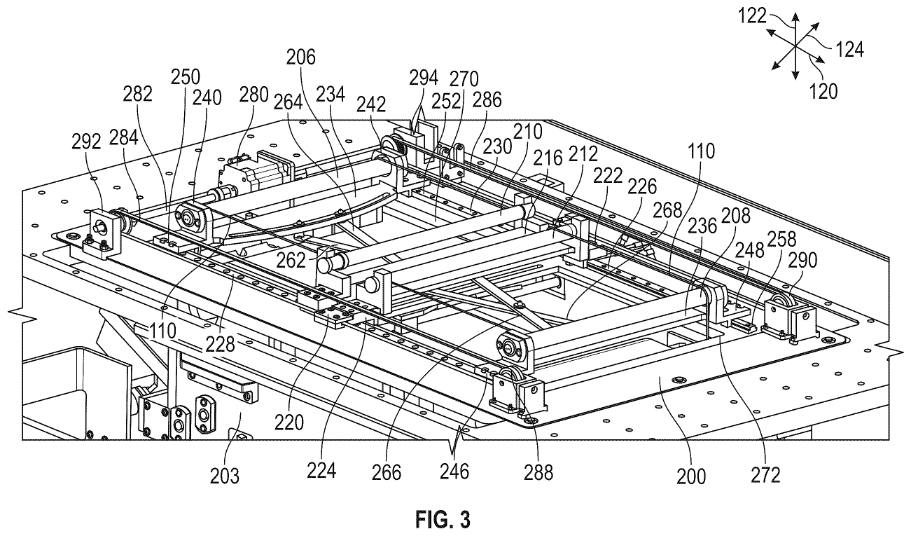

As noted above and referring again to FIG. 1, the transfer film 110 is shuttled back and forth between the material feed system 114 and the light engine 116 by a transfer film shuttle system 112. FIGS. 2 and 3 illustrate an embodiment of the transfer film shuttle system 112. The transfer film shuttle system 112 includes a shuttle platform 200, lower idle rollers 202, 204, upper idle rollers 206, 208, and retention rollers 210, 212. The lower idle rollers 202, 204 space the transfer film 110 from the base 150 of the light engine 116 in the second axis 122, so that the transfer film 110 touches and slides across the base 150 of the light engine reducing the stressed that may be incurred if the transfer film 110 passed over the corners of the light engine 116 on either side of the base 150. The lower idle rollers 202, 204 rotate with the transfer film 110 as the transfer film 110 is shuttled back and forth relative to the material feed system 114 and the light engine 116. The lower idle rollers 202, 204 are supported in a rotating manner by mounts 203 that extend from the base of the shuttle platform 200 or from the light engine 116. Similarly, the transfer film 110 is supported by the upper idle rollers 206, 208, which may rotate with the transfer film 110 as it passes over the upper idle rollers 206, 208.

The transfer film 110 is secured at each end to the retention rollers 210, 212. The retention rollers 210, 212 are secured on a bridge 216. In embodiments, the retention rollers 210, 212 are retained in a non-rotating manner on the bridge 216. The bridge 216 spans the shuttle platform 200 in a third axis 124. The bridge 216 is secured to the shuttle platform 200 by two brackets 220, 222, one on either side of the bridge 216. The brackets 220, 222 each include a channel 224, 226 defined in the underside of the brackets 220, 222. A rail 228, 230, secured to each side of the shuttle platform 200 is received in each channel 224, 226 and the brackets 220, 222 slide over the rails 228, 230 in the first axis 120. The upper idle rollers 206, 208 are also each supported by a bridge 234, 236 that spans the shuttle platform 200, one on either side of the retention rollers 210, 212. The bridges 234, 236 both include brackets 240, 242, 246, 248 on either side of the bridges 234, 236 that include channels 250, 252, 256, 258 for receiving the rails 228, 230. The brackets 240, 242, 246, 248 move back and forth on the rails 228, 230 along the first axis 120. The upper idle rollers 206, 208 are spaced from the retention rollers 210, 212 by a pair tensioning brackets 262, 264, 266, 268. The first pair of tensioning brackets 262, 264 are secured between the first bridge 216 and the second bridge 234 and the second pair of tensioning brackets 266, 268 are secured between the first bridge 216 and the third bridge 236. Each pair of tensioning brackets 262, 264, 266, 268 are also secured together at or near the center of the brackets 262, 264, 266, 268 in a rotatable manner so that the ends of the brackets 262, 264, 266, 268 may be brought together and secured in place to make the distance between the bridges 216, 234, 236 farther apart, or so that the ends of the brackets 262, 264, 266, 268 may be spread apart and secured in place to make the distance between the bridges 216, 234, 236 closer together. Openings 270, 272, in the shuttle platform 200 accommodate the movement of the transfer film 110 between the lower idle rollers 202, 204 and the upper idle rollers 206, 208.

In operation, the transfer film 110 is secured at a first end to the first retention roller 210, passes around the first upper idle roller 206, through the first opening 270, around the first lower idle roller 202, adjacent to the base 150 of the light engine 116, around the second lower idle roller 204, up through the second opening 272, around the second upper idle roller 208 and is secured to the second retention roller 210. A motor 280 is coupled to a shaft 282, which drives the first bridge 216 back and forth by a set of pulleys 284, 286. Each pulley 284, 286 is coupled to the shaft 282 at one side of the shuttle platform 200 and supported by either a second shaft or wheels 288, 290 at the opposing side of the shuttle platform 200. The shaft 282 is rotatably supported at the first side of the shuttle platform 200 by another set of brackets 292, 294. The brackets 220, 222 connected to the first bridge 216 are also connected to the set of pulleys 284, 286, so that movement of the pulleys 284, 286 along the first axis 120 translates into movement of the first bridge 216 along the first axis 120.

In alternative embodiments, the upper idle rollers 206, 208 are omitted and the retention rollers 210, 212 move on tracks. In yet further alternative embodiments, the ends of the transfer film 110 are not connected to the retention rollers 210, 212 but are connected together and the transfer film 110 rotates completely around, rather than shuttled back and forth. In such an embodiment, the pulleys 284, 286 are coupled to at least one of the upper idle rollers 206, 208 or at least one of the retention rollers 210, 212. In further embodiments, one or more of the driven rollers, i.e., the upper idle rollers 206, 208 or the retention rollers 210, 212, include a sprocket that engages with holes in the transfer film 110 for rotating the transfer film 110.

Turning again to FIG. 2, FIG. 2 illustrate an embodiment of a material feed system 114. In this embodiment, the material feed system 114 includes a gravity fed hopper 154. The outlet 156 of the gravity fed hopper 154 provides the polymer precursor between the transfer film 110 at the idle roller 202 and a feed roller 158. The feed roller 158 is rotatably held in an adjustable mount (not illustrated), that moves along the first axis 120, allowing the distance or gap between the feed roller 158 and the idle roller 204 to be adjusted. In addition, the feed roller 158 is driven by a motor (not illustrated). Rate of speed of the feed roller 158 is adjustable, either by adjusting the motor speed or using a clutch.

In further embodiments, the gravity fed hopper 154 also include an auger 160 for moving the polymer precursor though the outlet 156 of the hopper 154. The rate of rotation of the auger 160 may be adjustable, depending on the feed rate of the polymer precursor. In yet additional or alternative embodiments, a pregranulator 161 may be used to roll the polymer precursor into small knurls, which is then dropped into the gravity fed hopper 154.

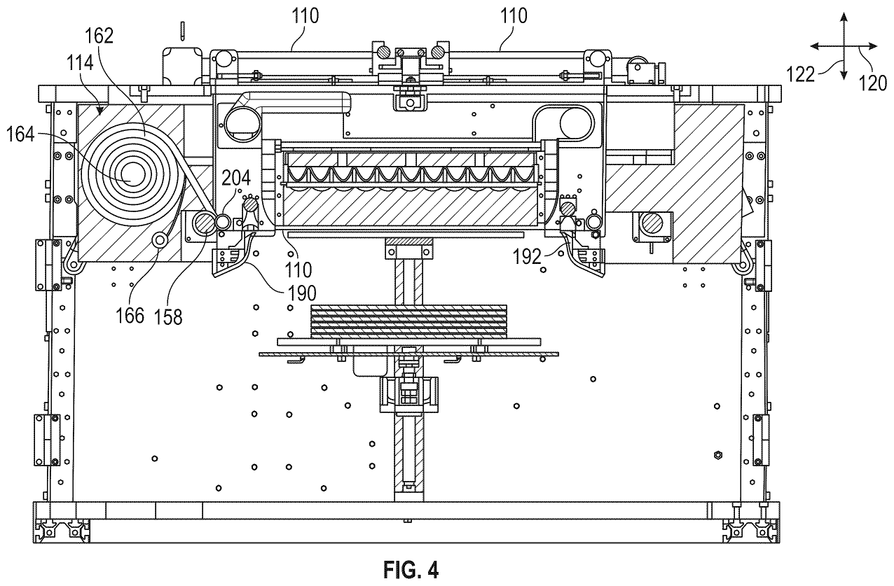

FIG. 4 illustrates another embodiment of a material feed system 114. In this embodiment, the polymer precursor is supplied in a green state, wherein the polymer precursor is not yet fully cured. The polymer precursor 162 is wrapped in layer onto a spool 164. In embodiments, the layers of the polymer precursor 162 may be carried by a release film 166 that is wrapped onto another roll as the polymer precursor is fed between the feed roller 158 and the transfer film 110 and idle roller 204. The figure illustrates the release film being removed prior to entering between the feed roller 158 and the idle roller 204; however, it should be appreciated that the release film 166 may be removed after the polymer precursor 162 passes through the feed roller 158 and the idle roller 204. Removing the release film 166 after it passes over the feed roller 158 prevents the release film from sticking to the feed roller 158. The feed roller 158 and idle roller 204 may again be used to adjust the thickness of the polymer precursor layer 128 as they are used in the additive manufacturing machine 100. Further, while the figure illustrates that the polymer precursor 128 is applied to the transfer film 110 as it passes between the feed roller 158 and the idle roller 204, in embodiments, a transfer film may be rolled up with the polymer precursor 162 and the release layer 166 in the spool 164.

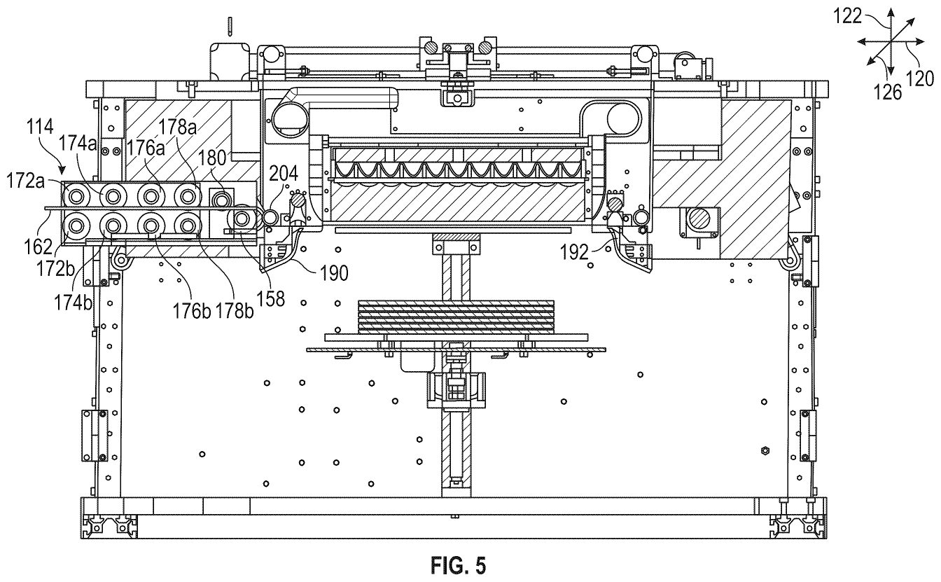

FIG. 5 illustrates yet another embodiment of a material feed system 114 for the additive manufacturing machine 100. In this embodiment, a roller train 170 may be used to feed the polymer precursor between the feed rollers 158 and the idle roller 204. As illustrated, the roller train 170 includes multiple roller pairs 172a, 172b, 174a, 174b, 176a, 176b, 178a, 178b. The distance or gaps between the rollers 172a, 172b, 174a, 174b, 176a, 176b, 178a, 178b in each pair may be adjusted in the second axis 122. For example, the gaps may be narrower as the polymer precursor 162 moves towards the feed roller 158, reducing the thickness of the polymer precursor. In addition, the distance or gaps between the roller pairs 172a, 172b, 174a, 174b, 176a, 176b, 178a, 178b may be adjusted in the first axis 120. A directional roller 180 is setup with additional degree of freedom in a fourth axis 126, within the plane defined by the first axis 120 and second axis 122, where the thickness between the directional roller 180 and feed roller 158 is controlled in the second axis 122 and the fourth axis 126 is used to adjust the offset of the center plane of the rollers to enable the transfer film, material, and release film to come together in a desired sandwich and then curl. Further, the diameter of the roller 180 is in a multiple of 0.25 to 1.5 in comparison to roller 158 to enable directional change of the film to then feed into roller train 170. While the polymer precursor 162 is illustrated as passing straight through the roller train 170, the polymer precursor 162 may take a more circuitous path through the roller train 170 with varying approach and departure angles between the roller pairs in the first axis 120. Further, as illustrated the polymer precursor travels through the roller train 170 relatively parallel to the support surface 106. However, the polymer precursor may travel at an angle to the support surface 106.

The rollers 172a, 172b, 174a, 174b, 176a, 176b, 178a, 178b may individually include heating and cooling elements, such as fluid circulation lines or resistive heating elements embedded under the roller surface. In additional or alternative embodiments, the rollers may individually include at least one of textured surfaces, perforated surfaces to break vacuum, variations in surface finish and coatings, as well as variations in the base materials used in the rollers.

In any of the above embodiments, excess polymer precursor may be removed from the transfer film 110 by squeegees 190, 192 placed on either side of the light engine 116. The squeegees 190, 192 may be rotated towards and away from the transfer film 110 or moved along the second axis 122 towards and away from the transfer film 110.

With reference again to FIG. 2, the light engine 116 includes a light source 300. The light source 300 is spaced away from a transparent plate 302, such as a glass plate, through which light emitted from the light source 300 passes. The transparent plate 302 also serves as a support for the transfer film 110, particularly as the print bed 104 is elevated to receive a polymer precursor layer 128. The light source 300 may include, but is not limited to, for example light emitting diodes, a liquid crystal display, and mercury lamps. The light source 300 may include an array of individual light source 300. Further, in embodiments, a light emitting diode array with collimation, a pixilated display, a projector, or a physical mask may be used to make the desired shapes and patterns for each cross section. The light source 300 may exhibit a power density as measured at the surface 143 of the previously deposited layer 140n+1 of 15 milliWatts per centimeter squared to 1000 milliWatts per centimeter squared, including all values and ranges therein, such as 100 milliWatts per centimeter squared to 500 milliWatts per centimeter squared. As noted above, the light emitted from the light source 300 exhibits one or more wavelengths in the range of 250 nanometers to 750 nanometers, including all values and ranges therein, such as one or more wavelengths in the range of 250 nanometers to 435 nanometers.

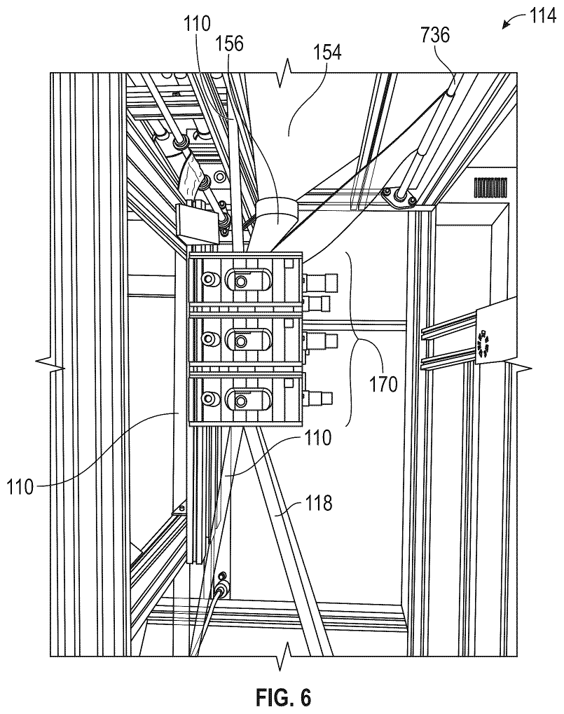

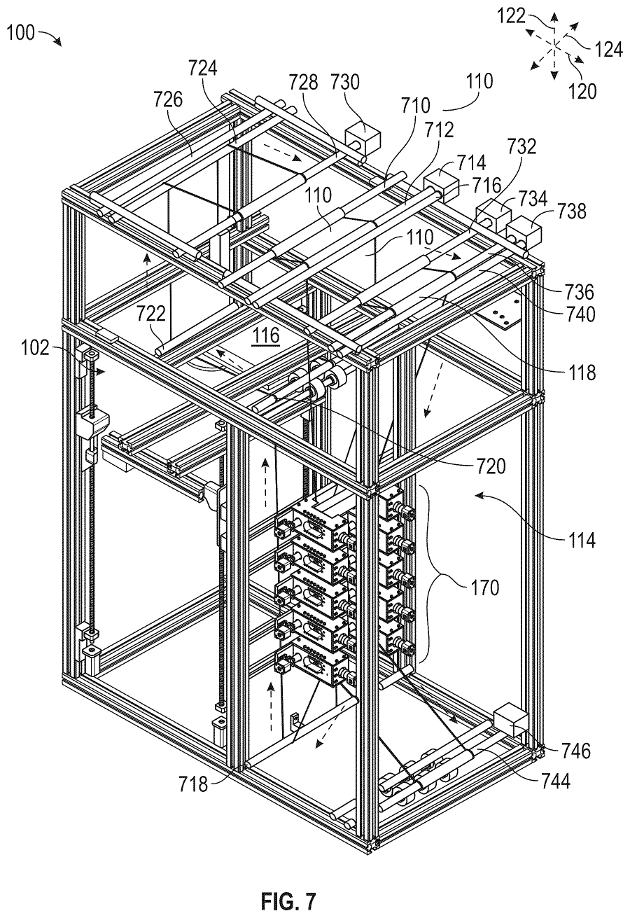

FIGS. 6 through 11 illustrate various modifications to the embodiments of the additive manufacturing machine 100 described above with reference to FIGS. 1 through 5. Each modification may be incorporated separately into the additive manufacturing machine 100 or corporately. As illustrated in FIGS. 6 and 7, the material feed system 114 is arranged to the side of the process chamber 102. The material feed system 114 includes a hopper a and a hopper outlet 156, which deposits a polymer precursor between the transfer film 110 and a release film 118. The polymer precursor is fed through the roller train 170 between the transfer film 110 and the release film 118 to prevent the polymer precursor from sticking to the rollers in the roller train 170. As the polymer precursor passes through the roller train 170 between the transfer film 110 and the release film 118, the thickness of the polymer precursor is adjusted and reduced to the desired print layer 140 thickness. As may be appreciated, while the thickness may be uniform, the thickness may be varied across the third axis. Further, the polymer precursor is illustrated as traveling through the roller train 170 generally perpendicular to the support surface 106.

FIG. 7 illustrates the path of the transfer film 110 and the release film 118 through the roller train 170. As illustrated, the transfer film 110 is unwound from a transfer film supply roller 710. The transfer film 110 then passes over a tension roller 712, which may be moved linearly along axis 120 by linear displacement drive 714, closer to or away from the supply roller 710, to apply tension to the transfer film 110. A nip roller 716 may be provided adjacent the tension roller 712, which may be used to apply pressure against the transfer film 110 and the tension roller 712. The transfer film 110, along with the release film 118 and the polymer precursor, pass through the roller train 170. The release film 118 separates from the transfer film 110 and the polymer precursor. The transfer film 110, including the polymer precursor, then passes down, under the lower idle roller 718 and back up to the process chamber entrance idle roller 720. The transfer film 110 with the polymer precursor then passes under the light engine 116 and remains until the print layer is deposited. Once the print layer is deposited the transfer film 110 passes up and around a second tension roller 724. In embodiments, a second nip roller 736 applies pressure against the transfer film 110 and the second tension roller 724. The transfer film 110 is then wound onto a storage roller 728. The storage roller 728 may be coupled to a motor that winds and unwinds the storage roller 728. Once a layer, or a plurality of layers of polymer precursor have been deposited onto the component 142, the transfer film 110 may be unwound from the storage roller 728 and wound back onto the supply roller 710, moving backwards through the path described above.

The release film 118 is unwound from a second, release film supply roller 732, which may be connected to a motor 734 for winding and unwinding the release film 118. The release film 118 then passes over a tension roller 736, which may be moved linearly along axis 120 by linear displacement drive 738, closer to or away from the supply roller 732, to apply tension to the release film 118. A nip roller 740 may be provided adjacent the tension roller 736, which may be used to apply pressure against the release film 118 and the tension roller 736. The release film 118, along with the transfer film 110 and the polymer precursor, pass through the roller train 170. Then the release film 118 is separated from the transfer film 110 and polymer precursor and is wound around a release film take-up roller 744, which may be driven by a take-up motor 746.

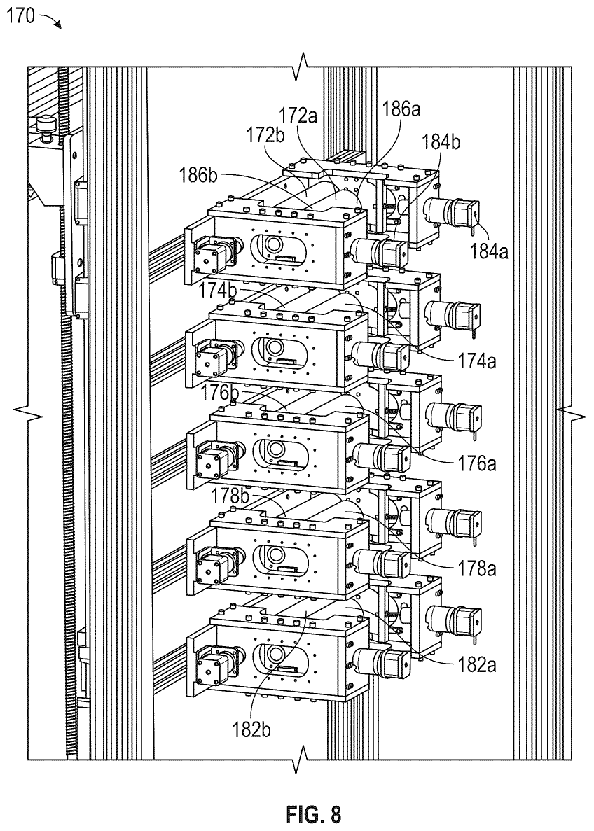

FIG. 8 illustrates an embodiment of a roller train 170, which may be used in the embodiment and orientation depicted in FIGS. 1 through 5 as well as in the embodiment and orientation illustrated in FIGS. 6 and 7. The roller train 170 illustrated as including five pairs of rollers, 172a, 172b, 174a, 174b, 176a, 176b, 178a, 178b, 182a, 182b. It should be appreciated, however, that fewer than five, or greater than five pairs of rollers may be present, such as in the range of one pair to 10 pairs, including all values and ranges therein, wherein the number of pairs may be selected based on polymer precursor composition, polymer precursor viscosity, etc. Each pair of rollers includes a transfer roller (172a, 174a, 176a, 178a, 182a) that contacts the transfer film 110 and a release roller (172b, 174b, 176b, 178b, 182b) that contacts the release film. The positions of the transfer rollers are fixed. The release rollers are each driven by two motors, 184a, 184b, which are used to linearly displace each end 186a, 186b of the release roller 172b relative to the transfer roller 172a. As noted, the motors 184a, 184b may maintain the same spacing between each end 186a, 186b, resulting in a uniform thickness across the polymer precursor, or may be used to maintain different spacing between each end 186a, 186b resulting in one side of the polymer precursor exiting the rollers 172a, 172b being thicker than the other side of the polymer precursor. As noted above, the transfer rollers and release rollers are, in embodiments, formed from a metallic material. Further, in embodiments, surface features are imparted to the roller surfaces to assist in release of the polymer precursor or to texturize the polymer precursor.

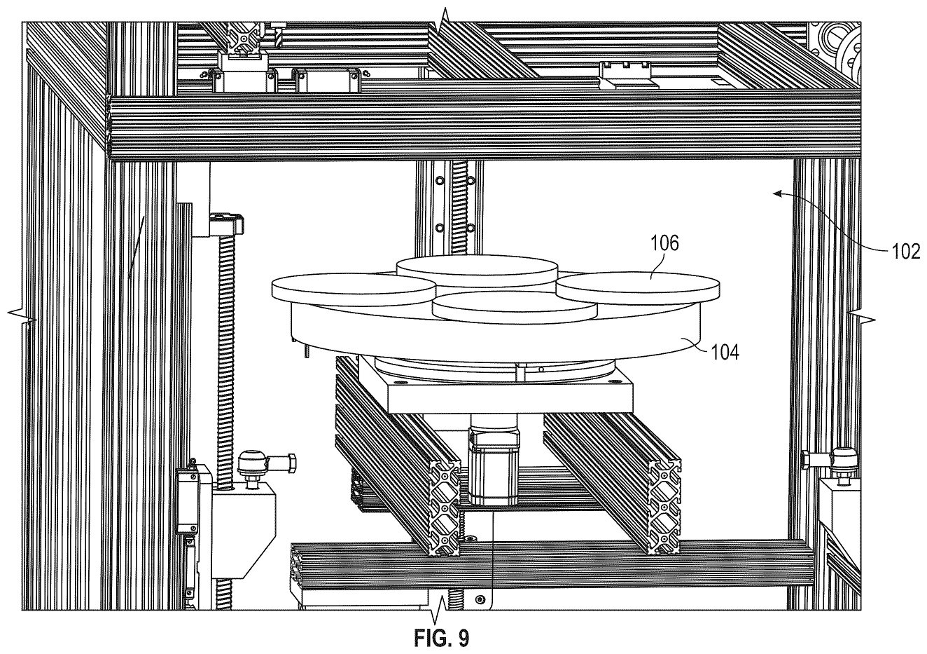

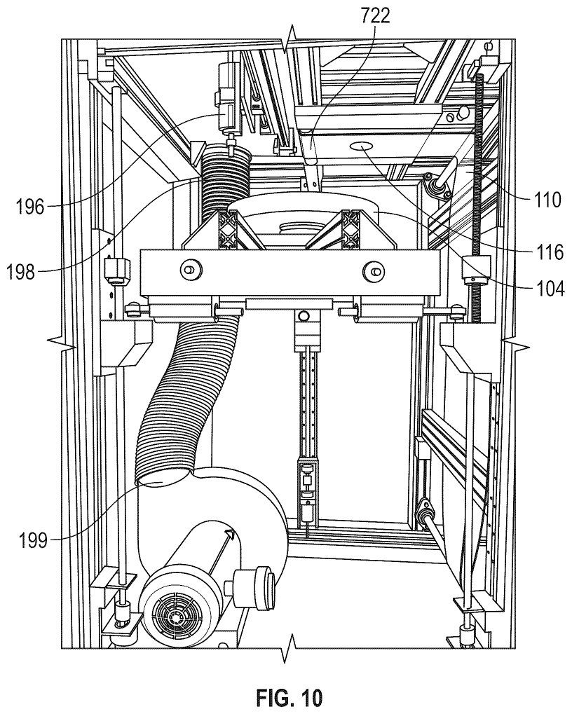

FIGS. 9 and 10 illustrates an embodiment of a rotatable print bed 104 that includes a number of support surfaces 106. Like the print bed 104 of FIGS. 1 through 5, the print bed 104 is movable vertically, in a second axis 122, relative to the light engine. The rotatable print bed 104 rotates in a plane defined by a first, horizontal axis 120 and a second horizontal axis 124. However, in embodiments, rotatable print bed 104 may rotate at an angle to that plane. The support surfaces 106 are also indexable upon rotation of the print bed 104 so that multiple components 142 may be formed simultaneously, wherein polymer precursor is being deposited on one component and another component is undergoing post processing. In embodiments, the support surfaces 106 are indexable between a first position under the light engine 116 and a second position adjacent to a post processing device 196. Indexing the support surface 106 towards the post processing device 196 moves the support surface 106 past the idle roller 722 and out from under the light engine 116 and transfer film 110. As illustrated, the post processing device 196 includes a milling machine for milling the printed component 142 after depositing a few layers. However, the post processing device 196 may include one or more devices, including at least one of a milling machine, a router, a knife, a polishing element (such as a polishing stone, sandpaper, foam polishing pad, microfiber pad), and a drill. The post processing devices 196 assist in adjusting the dimensions and surface finish of the printed component. FIG. 10 also illustrates a vacuum 198 that may be incorporated into the machine near the post processing device 196 in the process chamber 102, for catching dust and debris resulting from post processing. The vacuum 198 is powered by a vacuum pump 199.

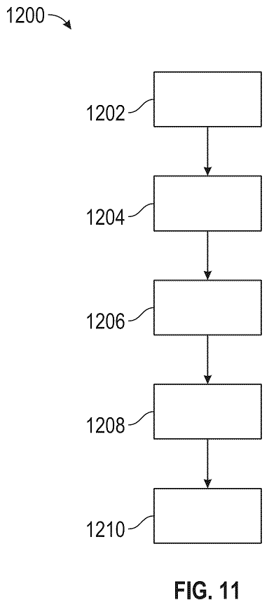

FIG. 11, with further reference to FIGS. 1 through 10, illustrates a general method 1200 of forming a part using the additive manufacturing machine 100. At block 1202 a polymer precursor is deposited onto a transfer film 110. The transfer film 110 is moved towards the light engine 116 as the polymer precursor is being deposited onto the transfer film 110 to form a layer of the polymer precursor on the transfer film 110. The speed of the rotation of the feed roller 158 and the speed of the transfer film 110 will alter the thickness and other characteristics of the polymer precursor layer 128. At block 1204, the print bed 104 and support surface 106 are raised towards the light engine 116 and the support surface, or a previously printed layer 140n+1, contact the polymer precursor layer 128 on the transfer film 110. At block 1206 the light engine activates a light source 300 within the light engine 116. The light source 300 casts light in a desired pattern onto the polymer precursor layer 128 to at least partially cure the polymer precursor layer 128 and, if a previously printed layer 140n+1 is present bind the layer being cured to the previously printed layer 140n+1. At block 1208, the at least partially cured polymer precursor layer 128 is transfer to the support surface 106 or the previously printed layer 140n+1 as the print bed 104 is lowered. At block 1210, if the polymer precursor layer 128 has not been fully cured, the polymer precursor layer 128 is cured when the next layer is printed or cured in a post printing process by applying light to the component.

The machines and methods herein offer a number of advantages. These advantages include, for example, the ability to produce three-dimensional components from polymer precursors that are at least one of 1) viscous and 2) highly filled materials, having additive levels of up to 99 percent by volume. The viscosities of the materials may be as great as 200,000,000 Centipoise or greater. Another advantage includes the ability to print polymer precursors that may be sensitive to high energy inputs due to the incendiary nature of the polymer precursors.

1. An additive manufacturing machine, comprising:
a light engine;
a material feed system configured to feed a polymer precursor exhibiting a viscosity in the range of 1,000 to 200,000,000 centipoise, wherein the material feed system includes a hopper and a roller train, wherein the hopper delivers the polymer precursor to the roller train and the polymer precursor passes through the roller train;
a transfer film configured to carry the polymer precursor and move between the material feed system and the light engine; and
a support surface for receiving the polymer precursor, moveable vertically towards and away from the light engine.

2. The additive manufacturing system of claim 1, further comprising at least two support surfaces, wherein the support surfaces are supported by a rotatable print bed and the support surfaces are indexable between a first position under the light engine to a second position adjacent a post processing device.

3. The additive manufacturing system of claim 2, wherein the post processing device includes at least one of a milling machine, a router, a knife, a polishing element, and a drill.

4. The additive manufacturing system of claim 1, wherein the material feed system includes an idle roller for supporting the transfer film, and the roller train includes a directional roller, wherein the roller train feeds the polymer precursor onto the transfer film between the directional roller and the idle roller.

5. The additive manufacturing system of claim 1, further comprising a release film, wherein the release film and the transfer film are configured to pass through the roller train, the hopper is configured to deposit the polymer precursor between the release film and the transfer film prior to the film entering the roller train, and the release film is configured to separate from the transfer film and polymer precursor upon exiting the roller train.

6. The additive manufacturing system of claim 5, wherein the roller train includes a transfer roller that contacts the transfer film and a release roller that contacts the release film, and the transfer film and the release film pass through the transfer roller and the release roller.

7. The additive manufacturing system of claim 6, wherein the release roller includes a first end and a second end, a first motor configured to linearly adjust the first end of the release roller relative to the transfer roller, and a second motor configured to linearly adjust the second end of the release roller relative to the transfer roller.

8. The additive manufacturing system of claim 5, further comprising a transfer film supply roller, wherein the transfer film is configured to be unwound from the transfer film supply roller before the transfer film passes through the roller train; and a release film supply roller, wherein the release film is configured to be unwound from the release film supply roller before the release film passes through the roller train.

9. The additive manufacturing system of claim 8, further comprising a release film take-up roller, wherein the release film is configured to be wound around the release film take-up roller after the release film passes through the roller train.

10. The additive manufacturing system of claim 8, further comprising a first tension roller and a first nip roller, wherein the transfer film is configured to pass through the first tension roller and the first nip roller prior to passing through the roller train.

11. The additive manufacturing system of claim 10, further comprising a lower idle roller, an upper idle roller, and a storage roller, wherein the transfer film is configured to pass under the lower idle roller after the transfer film passes through the roller train and around the upper idle roller prior to passing under the light engine, and wherein the transfer film is configured to be wound around the storage roller after the transfer film passes under the light engine.

12. The additive manufacturing system of claim 11, further comprising a second tension roller and a second nip roller, wherein the transfer film is configured to pass between the second tension roller and second nip roller after passing under the light engine and before being wound around the storage roller.

13. The additive manufacturing system of claim 2, further comprising a vacuum disposed proximal to the post-processing device.

14. A method for additive manufacturing, comprising:
depositing a polymer precursor onto a transfer film;
passing the polymer precursor through a roller train;
moving the transfer film including the polymer precursor under a light engine;
raising a support surface toward the light engine and the polymer precursor on the transfer film;
contacting the polymer precursor with at least one of the support surface and a previously printed layer on the support surface;
activating a light source in to at least partially cure the polymer precursor; and
transferring the at least partially cured the polymer precursor onto at least one of the support surface and the previously printed layer on the support surface to form a component.

15. The method of claim 14, further comprising indexing the support surface adjacent a post processing device and adjusting a dimension of the component with the post processing device.

16. The method of claim 14, wherein the polymer precursor is deposited on the transfer film after passing through the roller train.

17. The method of claim 14, further comprising sandwiching the polymer precursor between the transfer film and a release film; passing the transfer film, the release film, and the polymer precursor through the roller train; and removing the release film prior to raising the support surface toward the light engine and the polymer precursor on the transfer film.

18. The method of claim 17, further comprising unwinding the transfer film from a transfer film supply roller and passing the polymer film between a first tension roller and a first nip roller before sandwiching the polymer precursor between the transfer film and the release film.

19. The method of claim 17, further comprising passing the transfer film under a lower idle roller, and around an upper idle roller before moving the transfer film and polymer precursor under the light engine; and winding the transfer film onto a storage roller after transferring the at least partially cured polymer precursor onto the at least one of the support surface and the previously printed layer on the support surface.

20. The method of claim 17, further comprising unwinding the release film from a release film supply roller before sandwiching the polymer precursor between the transfer film and the release roller; separating the release film from the polymer precursor and transfer film after the release film passes through the roller train; and winding the release film on a release film take up roller.
